(19) United States
(12) Patent Application Publication
(10) Pub. No.: US 2024/0236722 A1
(43) Pub. Date: Jul. 11, 2024

(54) REPORTING BEAM INFORMATION IN BEAM FAILURE RECOVERY

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/558,887

(22) PCT Filed: Jul. 5, 2021
(86) PCT No.: PCT/CN2021/104437

§ 371 Date: Nov. 3, 2023

(51) Int. Cl. H04W 24/04; H04B 7/06

(52) U.S. Cl. CPC H04W 24/04; H04B 7/0695

(57) ABSTRACT

When a user equipment (UE) detects that a beam used to communicate with a base station has failed, the UE may transmit a beam failure recovery message to initiate a beam failure recovery procedure. Furthermore, the beam failure recovery message may include a new beam indication (NBI) to indicate a new beam in a candidate beam set with a measurement that satisfies a threshold. In such cases, the base station may enable communication using the new beam via dynamic signaling (e.g., downlink control information). Otherwise, beam failure recovery is performed using radio resource control signaling, which increases latency. Accordingly, some aspects described herein relate to techniques and apparatuses to report beam information (e.g., a preferred new beam) in a beam failure recovery message in cases where the UE is unable to identify any beam in the candidate beam set with a measurement that satisfies the threshold.

### FIELD OF THE DISCLOSURE

Aspects of the present disclosure generally relate to wireless communication and to techniques and apparatuses for reporting beam information in beam failure recovery.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. 5G, which may be referred to as New Radio (NR), is a set of enhancements to the LTE mobile standard promulgated by the 3GPP. 5G is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in 4G, 5G, and other radio access technologies remain useful.

### SUMMARY

In a wireless network, a user equipment (UE) communicating using a carrier aggregation configuration may detect a beam failure associated with an active beam used to communicate via a primary cell (PCell) and/or one or more secondary cells (SCells) (e.g., due to a change in channel conditions, mobility of the UE, and/or other factors causing degraded performance for the active beam). In cases where the UE detects a beam failure in an SCell, the UE may perform a beam search to determine whether a candidate beam set associated with the SCell includes any candidate beams that offer suitable performance to replace the active beam that has failed. For example, the UE may be configured to measure a reference signal received power (RSRP) associated with the candidate beams in the candidate beam set, and may determine that a candidate beam may be suitable to replace the active beam based on the RSRP satisfying a beam failure recovery threshold. In such cases, the UE may transmit, to a base station, a beam failure recovery medium access control control element (BFR MAC-CE) that includes a new beam indication (NBI) for one or more SCells that have experienced a beam failure. For example, a first (e.g., initial) octet in the BFR MAC-CE may be a bitmap that indicates one or more SCells that have experienced a beam failure, and subsequent octets in the BFR MAC-CE may include a candidate reference signal identifier that indicates a candidate new beam to replace the failed active beam (e.g., a candidate beam with an RSRP that satisfies the beam failure recovery threshold). In this way, the BFR MAC-CE may reduce beam failure recovery latency because the base station can use dynamic signaling (e.g., downlink control information) to enable the new beam based on the NBI included in the BFR MAC-CE. Otherwise, if the UE is unable to identify a candidate beam in the candidate beam set with an RSRP that satisfies the beam failure recovery threshold, the UE and the base station may need to rely upon radio resource control (RRC) signaling to select a new beam, which increases beam failure recovery latency.

Some aspects described herein relate to techniques and apparatuses to report beam information in a beam failure recovery message in cases where a UE is unable to identify a candidate beam in a candidate beam set with an RSRP measurement that satisfies a beam failure recovery threshold. For example, rather than leaving the candidate reference signal identifier field as a reserved field when the candidate beam set does not include a candidate beam with an RSRP measurement that satisfies the beam failure recovery threshold, the UE may identify a preferred new beam (e.g., a synchronization signal block (SSB) beam, channel state information reference signal (CSI-RS) beam, or transmission configuration indication (TCI) state) that is not included in the candidate beam set and/or has an RSRP measurement that does not satisfy the beam failure detection threshold. For example, the preferred new beam may be a candidate beam in the candidate beam set that has an RSRP measurement that does not satisfy the beam failure detection threshold, or the preferred new beam may be a candidate beam that is not included in the candidate beam set and has an RSRP measurement that satisfies or does not satisfy the beam failure detection threshold. In this way, the UE may report information in a beam failure recovery message to indicate a preferred new beam in cases where the candidate beam set does not include a candidate beam with an RSRP measurement that satisfies the beam failure recovery threshold, which may reduce beam failure recovery latency because the base station can use dynamic signaling to configure a new beam based on the preferred new beam.

Some aspects described herein relate to a method of wireless communication performed by a UE. The method may include transmitting, to a base station, a beam failure recovery message that indicates a preferred new beam associated with an SCell, wherein the preferred new beam is not included in a candidate beam set associated with the SCell or has an RSRP that does not satisfy a threshold. The method may include receiving, from the base station, one or more downlink messages that include information to enable communication using the preferred new beam.

Some aspects described herein relate to a method of wireless communication performed by a base station. The method may include receiving, from a UE, a beam failure recovery message that indicates a preferred new beam associated with an SCell, wherein the preferred new beam is not included in a candidate beam set associated with the SCell or has an RSRP that does not satisfy a threshold. The method may include transmitting, to the UE, one or more downlink messages that include information to enable communication using the preferred new beam.

Some aspects described herein relate to a UE for wireless communication. The user equipment may include a memory and one or more processors coupled to the memory. The one or more processors may be configured to transmit, to a base station, a beam failure recovery message that indicates a preferred new beam associated with an SCell, wherein the preferred new beam is not included in a candidate beam set associated with the SCell or has an RSRP that does not satisfy a threshold. The one or more processors may be configured to receive, from the base station, one or more downlink messages that include information to enable communication using the preferred new beam.

Some aspects described herein relate to a base station for wireless communication. The base station may include a memory and one or more processors coupled to the memory. The one or more processors may be configured to receive, from a UE, a beam failure recovery message that indicates a preferred new beam associated with an SCell, wherein the preferred new beam is not included in a candidate beam set associated with the SCell or has an RSRP that does not satisfy a threshold. The one or more processors may be configured to transmit, to the UE, one or more downlink messages that include information to enable communication using the preferred new beam.

Some aspects described herein relate to a non-transitory computer-readable medium that stores a set of instructions for wireless communication by a UE. The set of instructions, when executed by one or more processors of the UE, may cause the UE to transmit, to a base station, a beam failure recovery message that indicates a preferred new beam associated with an SCell, wherein the preferred new beam is not included in a candidate beam set associated with the SCell or has an RSRP that does not satisfy a threshold. The set of instructions, when executed by one or more processors of the UE, may cause the UE to receive, from the base station, one or more downlink messages that include information to enable communication using the preferred new beam.

Some aspects described herein relate to a non-transitory computer-readable medium that stores a set of instructions for wireless communication by a base station. The set of instructions, when executed by one or more processors of the base station, may cause the base station to receive, from a UE, a beam failure recovery message that indicates a preferred new beam associated with an SCell, wherein the preferred new beam is not included in a candidate beam set associated with the SCell or has an RSRP that does not satisfy a threshold. The set of instructions, when executed by one or more processors of the base station, may cause the base station to transmit, to the UE, one or more downlink messages that include information to enable communication using the preferred new beam.

Some aspects described herein relate to an apparatus for wireless communication. The apparatus may include means for transmitting, to a base station, a beam failure recovery message that indicates a preferred new beam associated with an SCell, wherein the preferred new beam is not included in a candidate beam set associated with the SCell or has an RSRP that does not satisfy a threshold. The apparatus may include means for receiving, from the base station, one or more downlink messages that include information to enable communication using the preferred new beam.

Some aspects described herein relate to an apparatus for wireless communication. The apparatus may include means for receiving, from a UE, a beam failure recovery message that indicates a preferred new beam associated with an SCell, wherein the preferred new beam is not included in a candidate beam set associated with the SCell or has an RSRP that does not satisfy a threshold. The apparatus may include means for transmitting, to the UE, one or more downlink messages that include information to enable communication using the preferred new beam.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is diagram illustrating an example of a wireless network.

FIG. 2 is a diagram illustrating an example of a base station in communication with a user equipment (UE) in a wireless network.

FIG. 3A is a diagram illustrating an example of a beam failure recovery medium access control control element (BFR MAC-CE) including a new beam indication (NBI).

FIG. 3B is a diagram illustrating a first example of a beam failure recovery procedure in which a BFR MAC-CE includes an NBI and a second example of a beam failure recovery procedure in which a BFR MAC-CE does not include an NBI.

FIG. 4 is a diagram illustrating an example associated with reporting beam information in beam failure recovery.

FIGS. 5-6 are flowcharts of example methods of wireless communication.

FIG. 7 is a diagram of an example apparatus for wireless communication.

FIG. 8 is a diagram illustrating an example of a hardware implementation for an apparatus employing a processing system.

FIG. 9 is a diagram of an example apparatus for wireless communication.

FIG. 10 is a diagram illustrating an example of a hardware implementation for an apparatus employing a processing system.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatuses and methods. These apparatuses and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

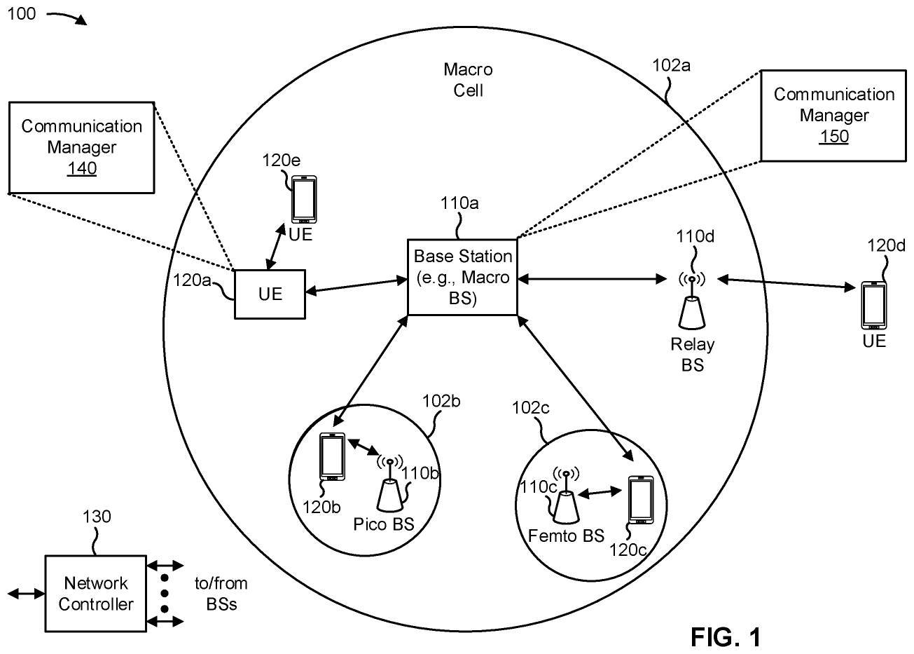

FIG. 1 is a diagram illustrating a wireless network 100 in which aspects of the present disclosure may be practiced. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a base station 110, a beam failure recovery message that indicates a preferred new beam associated with a secondary cell (SCell), wherein the preferred new beam is not included in a candidate beam set associated with the SCell or has a reference signal received power (RSRP) that does not satisfy a threshold; and receive, from the base station 110, one or more downlink messages that include information to enable communication using the preferred new beam. Additionally, or alternatively, the communication manager 140 may perform one or more other operations described herein.

In some aspects, the base station 110 may include a communication manager 150. As described in more detail elsewhere herein, the communication manager 150 may receive, from a UE 120, a beam failure recovery message that indicates a preferred new beam associated with an SCell, wherein the preferred new beam is not included in a candidate beam set associated with the SCell or has an RSRP that does not satisfy a threshold; and transmit, to the UE 120, one or more downlink messages that include information to enable communication using the preferred new beam. Additionally, or alternatively, the communication manager 150 may perform one or more other operations described herein.

As indicated above, FIG. 1 is provided as an example. Other examples may differ from what is described with regard to FIG. 1.

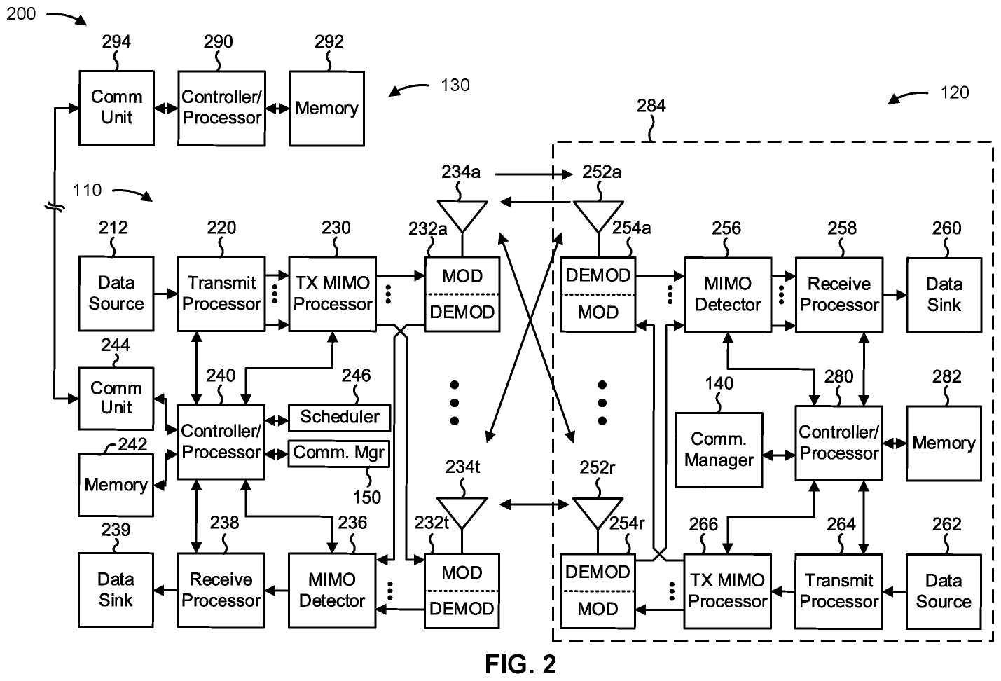

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The UE 120 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine an RSRP parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

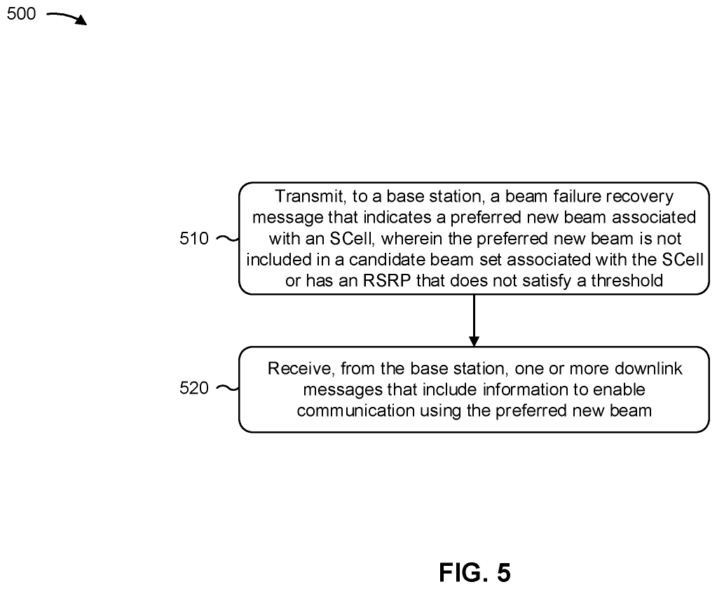

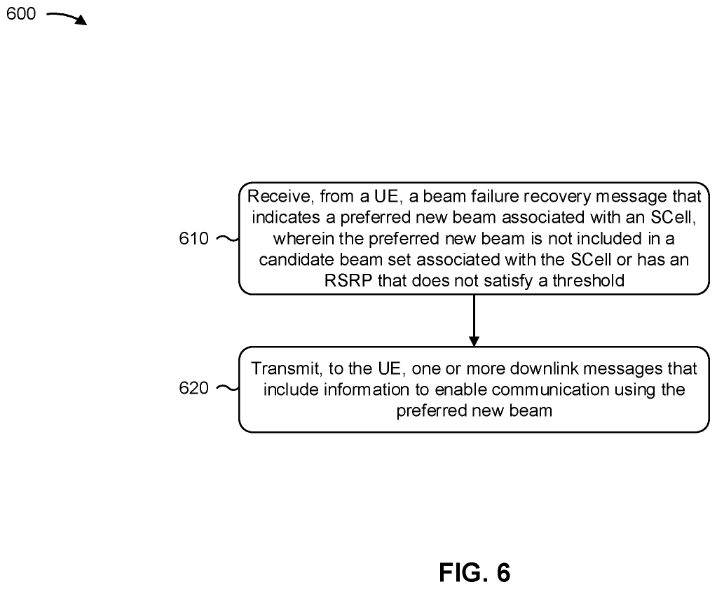

The controller/processor 240 of the base station 110, the controller/processor 280 of the UE 120, and/or any other component(s) of FIG. 2 may perform one or more techniques associated with reporting beam information in beam failure recovery, as described in more detail elsewhere herein. For example, the controller/processor 240 of the base station 110, the controller/processor 280 of the UE 120, and/or any other component(s) of FIG. 2 may perform or direct operations of, for example, method 500 of FIG. 5, method 600 of FIG. 6, and/or other methods as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, method 500 of FIG. 5, method 600 of FIG. 6, and/or other methods as described herein. In some examples, executing instructions may include running the instructions, converting the instructions, compiling the instructions, and/or interpreting the instructions, among other examples.

In some aspects, the UE 120 includes means for transmitting, to the base station 110, a beam failure recovery message that indicates a preferred new beam associated with a secondary cell (SCell), wherein the preferred new beam is not included in a candidate beam set associated with the SCell or has an RSRP that does not satisfy a threshold; and/or means for receiving, from the base station 110, one or more downlink messages that include information to enable communication using the preferred new beam. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for receiving, from the UE 120, a beam failure recovery message that indicates a preferred new beam associated with an SCell, wherein the preferred new beam is not included in a candidate beam set associated with the SCell or has an RSRP that does not satisfy a threshold; and/or means for transmitting, to the UE 120, one or more downlink messages that include information to enable communication using the preferred new beam. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

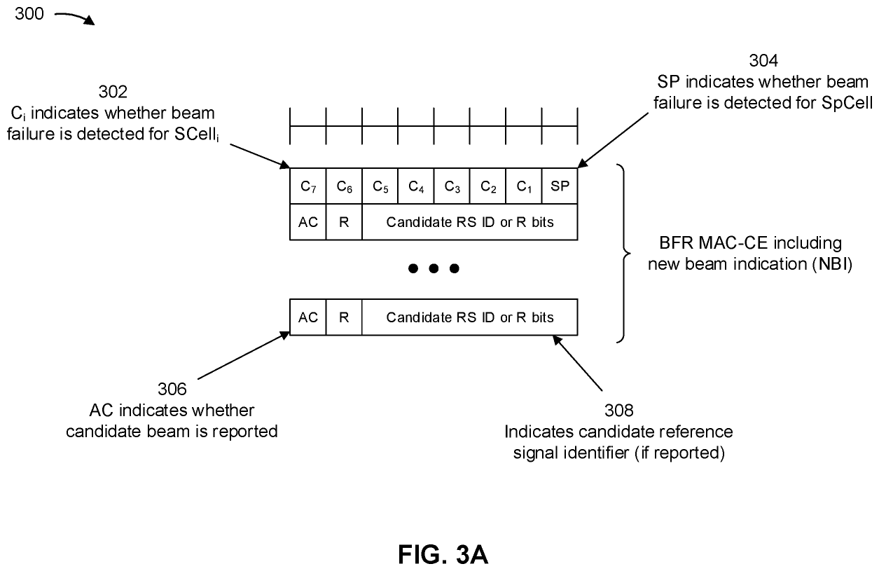

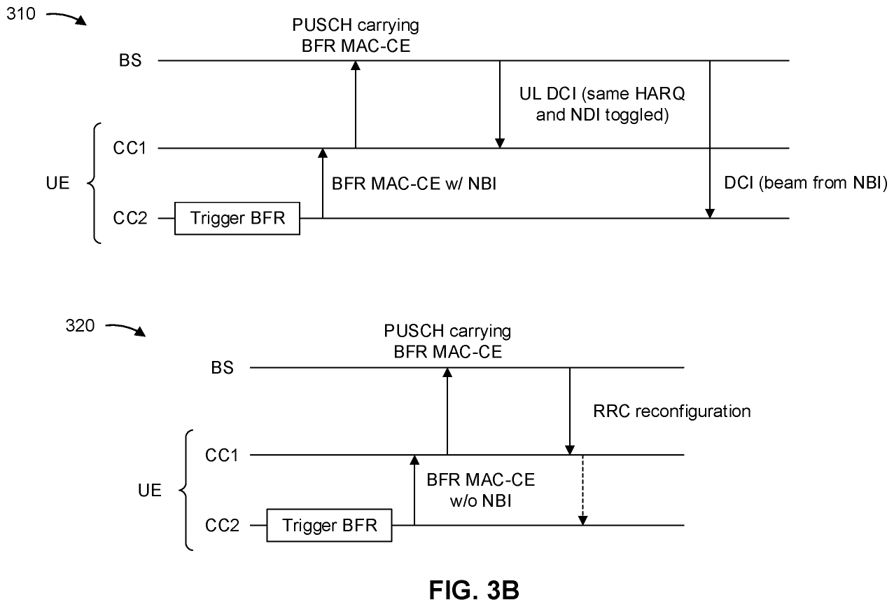

FIG. 3A is a diagram illustrating an example 300 of a beam failure recovery medium access control control element (BFR MAC-CE) including a new beam indication (NBI). As described herein, the BFR MAC-CE may have a structure that is defined to enable a UE to report beam failure detections for one or more component carriers in cases where the UE is configured to communicate with a base station using carrier aggregation. For example, using carrier aggregation, the base station and the UE may communicate with one another using a primary cell (PCell) and one or more secondary cells (SCells), where the one or more SCells may be configured for downlink communication only, for uplink communication only, or for downlink and uplink communication. Furthermore, in some cases, a single SCell in an SCell group (e.g., an SCell configured for downlink and uplink communication) may be configured as a primary secondary cell (PSCell), sometimes referred to as a special cell (SpCell).

For beam failure detection, the base station may configure the UE with one or more beam failure detection reference signals (e.g., a synchronization signal block (SSB) or channel state information reference signal (CSI-RS)), and the UE may declare a beam failure based on a number of beam failure instance indications from a physical (PHY) layer satisfying a threshold before a timer expires. In particular, the UE may detect a beam failure by counting the number of beam failure instance indications from the lower layer(s) to a medium access control (MAC) entity in the UE. Each time instance in which a measured beam fails to satisfy a configured threshold may be defined as a beam failure instance. If the number of consecutive beam failure instances satisfies a threshold, the UE declares a beam failure and initiates a beam failure recovery procedure. Additionally, or alternatively, the UE may detect a beam failure and initiate the beam failure recovery procedure based on a measurement (e.g., a Layer-1 RSRP (L1-RSRP)) associated with the beam failing to satisfy a threshold, among other examples.

In general, after the UE has detected a beam failure, the UE may trigger a beam failure recovery procedure in which the UE and the base station attempt to recover one or more beams that have ceased to function or operate correctly. In carrier aggregation, a beam failure recovery procedure can be performed in an attempt to recover a beam in a component carrier or a cell (e.g., in a PCell or an SCell). For example, when a beam failure occurs in an SCell, the UE may determine whether any candidate beams in a candidate beam set associated with the SCell (e.g., a candidate beam set configured in a candidateBeamRSSCellList parameter) have an RSRP measurement that satisfies a beam failure recovery threshold (e.g., a threshold configured in an rsrp-ThresholdBER parameter). In cases where the UE is able to identify one or more candidate beams that satisfy the beam failure recovery threshold, the UE may transmit a BFR MAC-CE that includes an NBI to indicate a new or replacement beam to use for SCell beam recovery.

For example, as shown in FIG. 3A, the BFR MAC-CE may generally include, in a first octet, a bitmap that indicates one or more SCells for which the UE detected a beam failure, which is followed by one or more octets that each contain a candidate beam availability indication (AC) that provides beam failure recovery information (e.g., an NBI) for the SCell(s) that are indicated in the bitmap (e.g., in an ascending order based on a serving cell index, ServCellIndex, associated with the indicated SCell(s)). For example, as shown at 302, the bitmap provided in the first octet of the BFR MAC-CE may include a set of Cᵢ fields, where each Cᵢ field indicates whether the UE is reporting a beam failure for an SCell with a serving cell index i and providing an octet that contains an NBI for the SCell with the serving cell index i. Accordingly, the Cᵢ field may be set to one (1) to indicate that the UE detected a beam failure in an SCell with the serving cell index i and to indicate an octet that contains an AC field is present in the BFR MAC-CE for the SCell with the serving cell index i (e.g., based on the UE identifying another beam in the candidate beam set for the SCell that has an RSRP that satisfies a beam failure recovery threshold). Otherwise, the Cᵢ field may be set to zero (0) to indicate either that a beam failure is not detected or that the UE has not identified another beam in the candidate beam set that has an RSRP that satisfies the beam failure recovery threshold).

As further shown at 304, the first octet in the BFR MAC-CE includes an SP field that may indicate whether beam failure detection occurred for the SpCell associated with the UE. For example, the SP field is set to one (1) to indicate that the UE detected a beam failure for the SpCell associated with the UE only when the BFR MAC-CE is included in a MAC protocol data unit (PDU) as part of a random access procedure; otherwise, the UE sets the SP field in the first octet to zero (0).

As further shown in FIG. 3A, the BFR MAC-CE may include one or more subsequent octets, following the first octet, that include an NBI for one or more SCells in which the UE detected a beam failure. For example, as shown at 306, an octet that contains an NBI to provide beam failure recovery information for an SCell may include an AC field to indicate the availability of a candidate beam for the SCell (e.g., a new beam that is suitable to replace the failed beam). For example, when the UE detects a beam failure in an SCell, the UE may evaluate candidate beams in a candidate beam set associated with the SCell in an attempt to find a suitable candidate (replacement) beam. Accordingly, the AC field may be set to one (1) to indicate that the candidate beam set (e.g., as indicated in a candidateBeamRSSCellList parameter) includes one or more SSBs and/or one or more CSI-RSs associated with an RSRP measurement that satisfies a beam failure recovery threshold (e.g., a synchronization signal RSRP (SS-RSRP) or a channel state information RSRP (CSI-RSRP) that satisfies a threshold indicated by an rsrp-ThresholdBFR parameter). Otherwise, the AC field may be set to zero (0) to indicate that the UE did not identify any SSB or CSI-RS in the candidate beam set with an RSRP measurement that satisfies the beam failure recovery threshold. Accordingly, when the AC field in an octet is set to 1, a candidate reference signal identifier may be provided in a candidate reference signal identifier field, or the octet may include reserved (R) bits in the candidate reference signal identifier field if the AC field is set to 0 (e.g., in addition to one reserved bit that follows the AC field, which is always set to 0).

As further shown in FIG. 3A, at 308, the candidate reference signal identifier field may be set to an index associated with a candidate beam having an RSRP measurement that satisfies the beam failure recovery threshold. When used to report a candidate new beam, the candidate reference signal identifier field may include six (6) bits to indicate an index associated with an SSB in the candidate beam set with an SS-RSRP that satisfies the beam failure recovery threshold or a CSI-RS in the candidate beam set with a CSI-RSRP that satisfies the beam failure recovery threshold. For example, the bits included in the candidate reference signal identifier field may correspond to an index associated with an entry in the candidate beam set, where index 0 corresponds to the first entry in the candidate beam set, index 1 corresponds to the second entry in the candidate beam set, and so on. In this way, when the BFR MAC-CE is used to provide an NBI for one or more SCells in which the UE has detected a beam failure, the NBI(s) may reduce beam failure recovery latency because the base station can use dynamic signaling (e.g., downlink control information (DCI)) to enable the new beam based on the NBI included in the BFR MAC-CE. Otherwise, if the UE is unable to identify a candidate beam in the candidate beam set with an RSRP that satisfies the beam failure recovery threshold, the UE and the base station may need to rely upon RRC signaling to select a new beam, which increases beam failure recovery latency.

For example, FIG. 3B is a diagram illustrating a first example 310 of a beam failure recovery procedure in which a BFR MAC-CE includes an NBI, and a second example 320 of a beam failure recovery procedure in which a BFR MAC-CE does not include an NBI. As shown in FIG. 3B, at 310 and 320, the UE may communicate using carrier aggregation, where the base station and the UE are configured to communicate using at least two component carriers (e.g., shown as CC1 and CC2, although the carrier aggregation configuration may include additional component carriers that are not explicitly shown). As shown at 310, the UE may detect a beam failure in an SCell corresponding to the second component carrier, and may identify a candidate beam in a candidate beam set with an RSRP measurement that satisfies a beam failure recovery threshold. In this case, as shown, the UE may generate a BFR MAC-CE in which the Cᵢ field corresponding to the SCell is set to 1 and another octet includes an NBI to indicate the index associated with the candidate beam that satisfies the beam failure recovery threshold, which may be provided (e.g., internally at the MAC layer) from the second component carrier that has experienced failure to a first component carrier that has not failed. Accordingly, as shown, the UE may transmit, to the base station via the first component carrier, a physical uplink shared channel (PUSCH) that carries the BFR MAC-CE with the NBI for the SCell that has experienced beam failure. In general, as described herein, the first component carrier may be any suitable cell that has not experienced a beam failure, which may be a PCell or a different SCell. The base station may then transmit one or more downlink messages to the UE using dynamic control signaling to enable communication using the new beam indicated in the BFR MAC-CE. For example, as shown, the downlink messages may include an uplink DCI message that includes uplink scheduling, which is transmitted via the first component carrier with the same hybrid automatic repeat request (HARQ) process identifier as the PUSCH carrying the BFR MAC-CE and a new data indicator (NDI) toggled to indicate that the uplink DCI message is a beam failure recovery response to the PUSCH carrying the BFR MAC-CE. As further shown at 310, after the uplink DCI message used as the beam failure recovery response, the base station may transmit DCI to the UE via the second component carrier using the beam associated with the NBI provided in the BFR MAC-CE.

Alternatively, as shown at 320, the UE may detect a beam failure in an SCell corresponding to the second component carrier, and may determine that the candidate beam set does not include any candidate beam with an RSRP measurement that satisfies the beam failure recovery threshold. In this case, as shown, the UE may generate a BFR MAC-CE without an NBI for the failed SCell, and the BFR MAC-CE may be internally communicated from the second component carrier to the first component carrier. For example, in the BFR MAC-CE, the Cᵢ field corresponding to the SCell may be set to 1 to indicate that beam failure was detected, but the octet that contains beam failure recovery for the SCell includes an AC field set to 0 and reserved bits in the candidate reference signal identifier field because the UE was unable to identify a candidate beam that satisfies the beam failure recovery threshold. In this case, as shown, the UE may transmit, to the base station via the first component carrier, a PUSCH that carries the BFR MAC-CE without the NBI for the SCell (e.g., with the AC field set to 0), which may trigger an RRC reconfiguration (e.g., via a random access procedure) to select and configure a new replacement beam. As a result, when the BFR MAC-CE does not include an NBI for an SCell that has experienced beam failure, recovery from the beam failure may be associated with a longer latency due to the need to rely on RRC signaling.

Accordingly, when used to report an NBI associated with an SCell that has experienced a beam failure, the BFR MAC-CE may include the candidate reference signal identifier field to indicate an index associated with an SSB, a CSI-RS, or a transmission configuration indication (TCI) state in a candidate beam set with an RSRP measurement that satisfies the beam failure recovery threshold. For example, as described herein, the candidate reference signal identifier field includes six (6) bits, whereby the candidate beam set may include up to sixty-four (64) candidate beams. In practice, however, the candidate beam set may include fewer than 64 candidate beams. Accordingly, in cases where the UE is unable to identify a candidate beam in the candidate beam set with an RSRP measurement that satisfies the beam failure recovery threshold, the candidate reference signal identifier field may be left as a reserved field, and beam failure recovery has to rely on an RRC reconfiguration that has a large latency (e.g., requiring more CSI reporting to select and/or refine a new beam), even though there may be other suitable beams that are not included in the candidate beam set. For example, in a bandwidth part, there may be up to one hundred twenty-eight (128) TCI states that can be used for downlink communication and/or for uplink communication or for joint downlink and uplink communication in a wireless network that supports a unified downlink and uplink TCI framework.

Accordingly, even in cases where the UE is unable to identify a candidate beam in the candidate beam set with an RSRP measurement that satisfies the beam failure recovery threshold, the UE may be able to find another suitable beam that is not included in the candidate beam set and/or has an RSRP measurement that does not satisfy the beam failure recovery threshold. For example, the UE may identify a preferred SSB or CSI-RS beam that is not included in the candidate beam set but has an RSRP measurement that satisfies the beam failure recovery threshold and/or a preferred SSB or CSI-RS beam that is included in the candidate beam set with an RSRP below the beam failure recovery threshold. Additionally, or alternatively, the UE may identify the preferred beam based on other measurements, such as a CSI report, or based on a demodulation reference signal (DMRS) that may not be included in the candidate beam set.

Some aspects described herein therefore relate to techniques and apparatuses to report beam information in a beam failure recovery message in cases where a UE is unable to identify a candidate beam in a candidate beam set with an RSRP measurement that satisfies a beam failure recovery threshold. For example, rather than leaving the candidate reference signal identifier field as a reserved field when the candidate beam set does not include a candidate beam with an RSRP measurement that satisfies the beam failure recovery threshold, the UE may identify a preferred new beam (e.g., a synchronization signal block (SSB) beam or channel state information reference signal (CSI-RS) beam) that is not included in the candidate beam set and/or has an RSRP measurement that does not satisfy the beam failure detection threshold. For example, the preferred new beam may be a candidate beam in the candidate beam set that has an RSRP measurement that does not satisfy the beam failure detection threshold, or the preferred new beam may be a candidate beam that is not included in the candidate beam set and has an RSRP measurement that satisfies or does not satisfy the beam failure detection threshold. In this way, the UE may report information in a beam failure recovery message to indicate a preferred new beam in cases where the candidate beam set does not include a candidate beam with an RSRP measurement that satisfies the beam failure recovery threshold, which may reduce beam failure recovery latency because the base station can use dynamic signaling to configure a new beam based on the preferred new beam (e.g., in a similar manner as beam failure recovery for a PCell, where the UE may trigger a contention-based random access procedure with a preferred beam that may have an RSRP measurement that is below or otherwise fails to satisfy a beam failure recovery threshold).

As indicated above, FIGS. 3A-3B are provided as examples. Other examples may differ from what is described with regard to FIGS. 3A-3B.

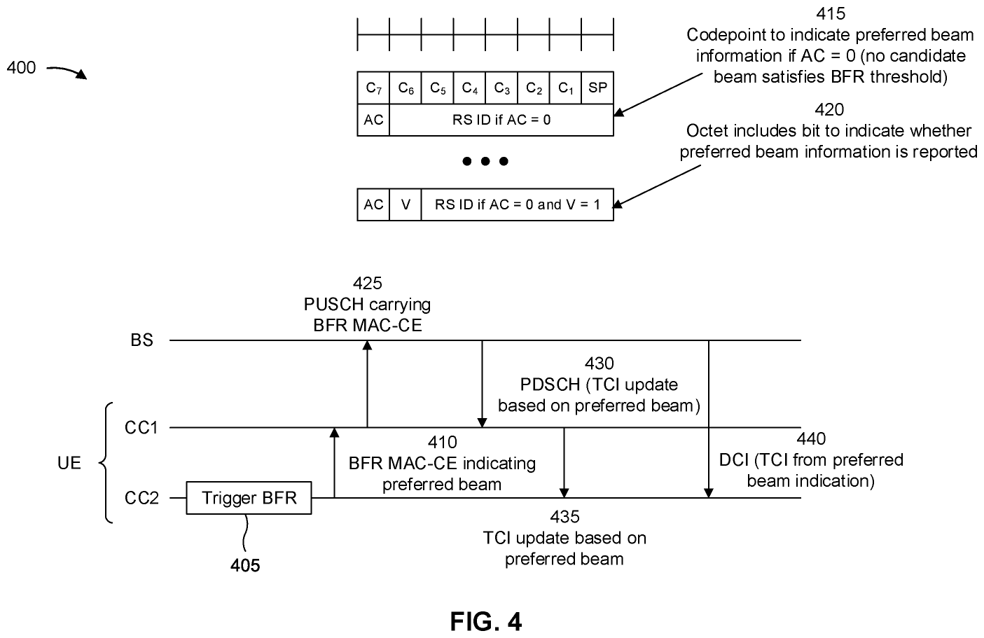

FIG. 4 is a diagram illustrating an example 400 associated with reporting beam information in beam failure recovery. As shown in FIG. 4, a base station and a UE may communicate with one another using carrier aggregation. Using carrier aggregation, the base station and the UE may communicate with one another using a PCell and one or more SCells. In some aspects, the one or more SCells may be configured for downlink communication only, for uplink communication only, or for downlink and uplink communication. Furthermore, in some aspects, a single SCell in an SCell group (e.g., an Scell configured for downlink and uplink communication) may be designated or configured as a primary secondary cell (PSCell) or a special cell (SpCell).

As shown at 405, the UE may trigger beam failure recovery on a second component carrier (shown as CC2) that corresponds to an SCell, based on detecting a beam failure. For example, as described herein, the base station may configure the UE with one or more beam failure detection reference signals, each of which may correspond to an SSB or a CSI-RS, and the UE may declare a beam failure based on a number of beam failure instance indications from a PHY layer satisfying a threshold before a timer expires. In particular, the UE may detect a beam failure by counting the number of beam failure instance indications from the lower layer(s) to a MAC entity in the UE. Each time instance in which the measured beam fails to satisfy a configured threshold may be defined as a beam failure instance. If the number of consecutive beam failure instances satisfies a threshold, the UE detects a beam failure and triggers the beam failure recovery procedure. Additionally, or alternatively, the UE may detect the beam failure and trigger the beam failure recovery procedure based on a measurement (e.g., an L1-RSRP) associated with the beam failing to satisfy a threshold, among other examples.

In some aspects, when the UE detects the beam failure on the SCell, the UE may evaluate candidate beams that are included in a candidate beam set associated with the SCell and configured for beam failure recovery. For example, the candidate beam set may include beams associated with one or more SSB indexes and/or CSI-RS indexes, and the UE may determine whether any of the candidate beams in the candidate beam set are associated with an RSRP measurement that satisfies a beam failure recovery threshold. In cases where the UE determines that one or more candidate beams in the candidate beam set are associated with an RSRP measurement that satisfies the beam failure recovery threshold, the UE may transmit, to the base station, a BFR MAC-CE that includes an NBI associated with a suitable replacement beam, as described above in connection with, for example, FIG. 3B at 310. However, according to some aspects described herein, the UE may be unable to identify any candidate beam in the candidate beam set with an RSRP measurement that satisfies the beam failure recovery threshold. For example, the UE may be unable to identify any candidate beam(s) in the candidate beam set with an L1-RSRP that satisfies the threshold configured for beam failure recovery. In such cases, as shown in FIG. 4 at 410, the UE may generate a BFR MAC-CE to indicate a preferred new beam that is not included in the candidate beam set and/or has an RSRP measurement that does not satisfy the beam failure recovery threshold. For example, in some aspects, the preferred new beam may be a candidate beam in the candidate beam set with an RSRP that does not satisfy the threshold, or the preferred new beam may not have a corresponding entry in the candidate beam set (in which case the associated RSRP measurement may be above, below, or equal to the beam failure recovery threshold). Accordingly, the BFR MAC-CE that indicates the preferred new beam may be internally communicated from the second (failed) component carrier to a first component carrier that has not experienced beam failure. For example, the first component carrier may be a PCell or another SCell that has not experienced beam failure.

In some aspects, the BFR MAC-CE that is generated by the UE to indicate the preferred new beam may include a first (initial) octet that provides a bitmap to indicate one or more SCells in which beam failure was detected. For example, the C₄ field in the bitmap may be set to one (1) to indicate that beam failure was detected in the fourth SCell. Accordingly, as described herein, the Cᵢ field associated with the second component carrier may be set to 1 to indicate that the second component carrier has experienced beam failure, and the AC field in the corresponding octet may be set to zero (0) to indicate that the UE is not reporting an NBI based on a candidate beam in the candidate beam set having an RSRP that satisfies the beam failure recovery threshold. However, rather than leaving the remaining seven bits in the octet as reserved bits, the other seven bits may be used to indicate a preferred new beam that is not included in the candidate beam set and/or has an RSRP that does not satisfy the beam failure recovery threshold.

For example, as shown at 415, the octet that includes the beam failure recovery information may include a seven bit reference signal identifier field (following the AC bit) that indicates a codepoint associated with a preferred new beam when the Cᵢ bit associated with an SCell is set to 1 and the AC bit in the octet that provides beam failure recovery information is set to 0. For example, in some aspects, the codepoint provided in the reference signal identifier field may correspond to a TCI state identifier, a CSI-RS identifier in a specific bandwidth part (e.g., an active bandwidth part), and/or a joint identifier associated with an SSB and a CSI-RS, among other examples. Furthermore, one codepoint may be configured or defined (e.g., ‘1111111’) to indicate that preferred beam information is not reported in the reference signal identifier field.

Alternatively, as shown at 420, the octet that includes the beam failure recovery information may include a six-bit reference signal identifier field that may indicate the codepoint associated with the preferred new beam (e.g., a codepoint corresponding to a TCI state identifier, a CSI-RS identifier in a specific bandwidth part, and/or a joint identifier associated with an SSB and a CSI-RS), and the reference signal identifier field may be preceded by a one-bit field (V field) that indicates whether a preferred new beam is reported in the BFR MAC-CE. For example, the V field may be set to one (1) to indicate that the reference signal identifier field includes information to indicate a preferred new beam that is not included in the candidate beam set and/or associated with an RSRP measurement that does not satisfy the beam failure recovery threshold. Otherwise, the V field may be set to zero (0) in cases where reference signal information associated with a preferred new beam is not reported in the BFR MAC-CE.

In some aspects, as shown at 425, the UE may transmit, to the base station via the first component carrier, a PUSCH that carries the BFR MAC-CE that indicates the preferred new beam(s) for the SCell(s) that have experienced beam failure. Accordingly, the base station may process the BFR MAC-CE to identify the preferred new beam(s) in a similar manner as a BFR MAC-CE that indicates a candidate replacement beam in a candidate beam set with an RSRP measurement that satisfies the beam failure recovery threshold. For example, in some aspects, the base station may transmit, and the UE may receive, one or more downlink messages to enable communication via the preferred new beam. For example, as shown at 430, the base station may transmit, to the UE via the first component carrier, a physical downlink shared channel (PDSCH) that includes a TCI state update for the second component carrier based on the preferred new beam indicated in the BFR MAC-CE. As further shown at 435, the UE may then apply the TCI state update based on the preferred new beam on the second component carrier. As further shown at 440, the base station may transmit, to the UE via the second component carrier, DCI that uses the TCI state associated with the preferred new beam. In this way, the UE may report beam information to reduce latency associated with recovering from beam failure in an SCell (e.g., by using dynamic control signaling rather than RRC reconfiguration messages that are associated with a large latency) in cases where the UE identifies a potentially suitable replacement beam that does not appear in the candidate beam set that is configured for the SCell and/or has an RSRP measurement that does not satisfy the beam failure recovery threshold that is configured for the SCell.

As indicated above, FIG. 4 is provided as an example. Other examples may differ from what is described with regard to FIG. 4.

FIG. 5 is a flowchart of an example method 500 of wireless communication. The method 500 may be performed by, for example, a UE (e.g., UE 120).

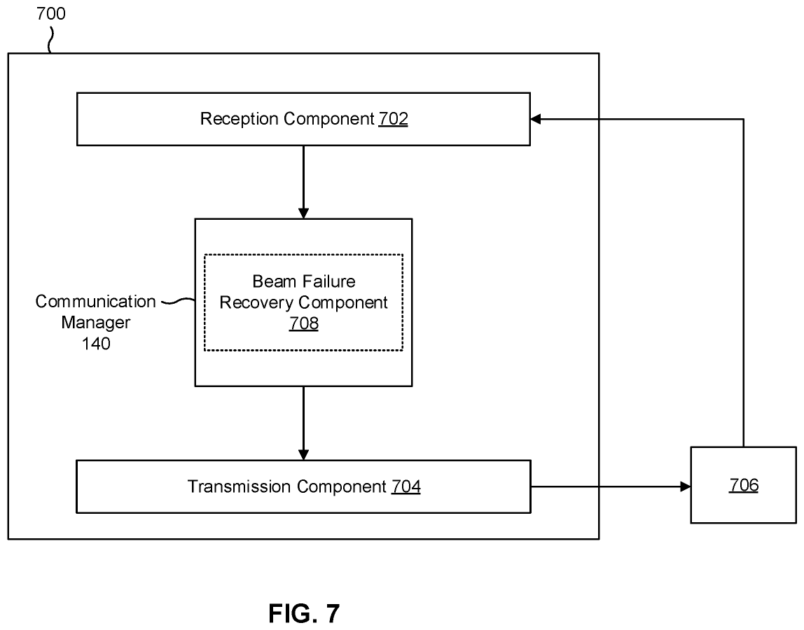

At 510, the UE may transmit, to a base station, a beam failure recovery message that indicates a preferred new beam associated with an SCell, wherein the preferred new beam is not included in a candidate beam set associated with the SCell or has an RSRP that does not satisfy a threshold. For example, the UE (e.g., using communication manager 140 and/or transmission component 704, depicted in FIG. 7) may transmit, to a base station, a beam failure recovery message that indicates a preferred new beam associated with an SCell, wherein the preferred new beam is not included in a candidate beam set associated with the SCell or has an RSRP that does not satisfy a threshold, as described above in connection with, for example, FIG. 4 at 410, 425. In some aspects, the beam failure recovery message indicates the preferred new beam according to a TCI state identifier, a CSI-RS identifier associated with a bandwidth part, and/or a joint identifier associated with an SSB and a CSI-RS.

At 520, the UE may receive, from the base station, one or more downlink messages that include information to enable communication using the preferred new beam. For example, the UE (e.g., using communication manager 140 and/or reception component 702, depicted in FIG. 7) may receive, from the base station, one or more downlink messages that include information to enable communication using the preferred new beam, as described above in connection with, for example, FIG. 4 at 430, 440.

In some aspects, the beam failure recovery message includes a BFR MAC-CE. In some aspects, the BFR MAC-CE includes a first octet having a field to indicate a beam failure detection associated with the SCell and includes a second octet to indicate information associated with the preferred new beam. In some aspects, the second octet includes a first field to indicate that the candidate beam set associated with the SCell does not include a reference signal that has an RSRP that satisfies the threshold and includes a second field to indicate a reference signal identifier associated with the preferred new beam. In some aspects, the second octet includes a third field to indicate that the reference signal identifier associated with the preferred new beam is reported in the second field.

Additionally, or alternatively, in some aspects, the second octet includes a first field to indicate that the candidate beam set associated with the SCell does not include a reference signal that has an RSRP that satisfies the threshold and includes a second field to indicate that a reference signal identifier is not reported for the preferred new beam. In some aspects, the second field includes a codepoint or an individual bit that is set to a defined value to indicate that the reference signal identifier is not reported for the preferred new beam.

Although FIG. 5 shows example blocks of method 500, in some aspects, method 500 may include additional blocks, fewer blocks, different blocks, or differently arranged blocks than those depicted in FIG. 5. Additionally, or alternatively, two or more of the blocks of method 500 may be performed in parallel.

FIG. 6 is a flowchart of an example method 600 of wireless communication. The method 600 may be performed by, for example, a base station (e.g., base station 110).

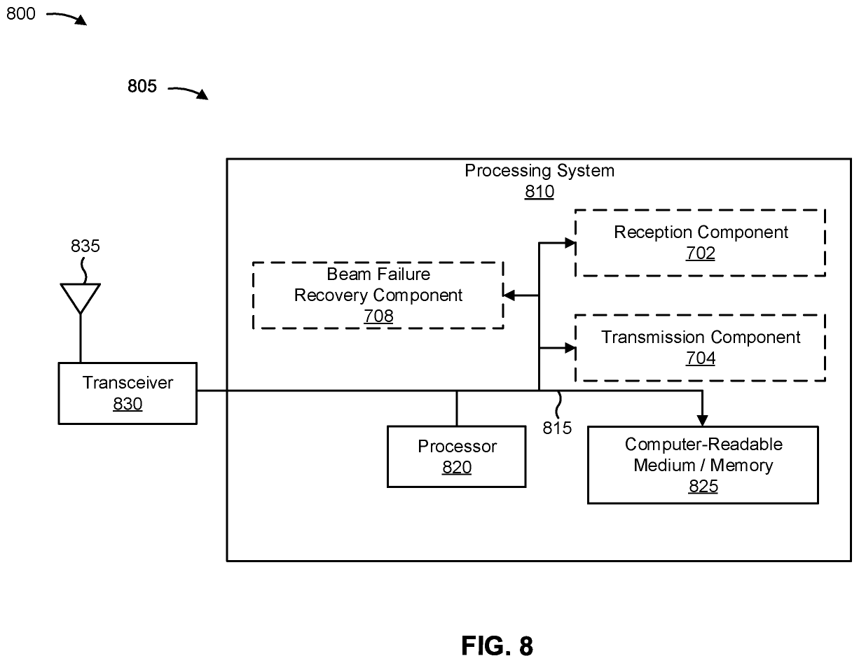

At 610, the base station may receive, from a UE, a beam failure recovery message that indicates a preferred new beam associated with an SCell, wherein the preferred new beam is not included in a candidate beam set associated with the SCell or has an RSRP that does not satisfy a threshold. For example, the base station (e.g., using communication manager 150 and/or reception component 702, depicted in FIG. 8) may receive, from a UE, a beam failure recovery message that indicates a preferred new beam associated with an SCell, wherein the preferred new beam is not included in a candidate beam set associated with the SCell or has an RSRP that does not satisfy a threshold, as described above in connection with, for example, FIG. 4 at 410, 425. In some aspects, the beam failure recovery message indicates the preferred new beam according to a TCI state identifier, a CSI-RS identifier associated with a bandwidth part, and/or a joint identifier associated with an SSB and a CSI-RS.

At 620, the base station may transmit, to the UE, one or more downlink messages that include information to enable communication using the preferred new beam. For example, the base station (e.g., using communication manager 150 and/or transmission component 704, depicted in FIG. 8) may transmit, to the UE, one or more downlink messages that include information to enable communication using the preferred new beam, as described above in connection with, for example, FIG. 4 at 430, 440.

In some aspects, the beam failure recovery message includes a BFR MAC-CE. In some aspects, the BFR MAC-CE includes a first octet having a field to indicate a beam failure detection associated with the SCell and includes a second octet to indicate information associated with the preferred new beam. In some aspects, the second octet includes a first field to indicate that the candidate beam set associated with the SCell does not include a reference signal that has an RSRP that satisfies the threshold and includes a second field to indicate a reference signal identifier associated with the preferred new beam. In some aspects, the second octet includes a third field to indicate that the reference signal identifier associated with the preferred new beam is reported in the second field.

Additionally, or alternatively, in some aspects, the second octet includes a first field to indicate that the candidate beam set associated with the SCell does not include a reference signal that has an RSRP that satisfies the threshold and includes a second field to indicate that a reference signal identifier is not reported for the preferred new beam. In some aspects, the second field includes a codepoint or an individual bit that is set to a defined value to indicate that the reference signal identifier is not reported for the preferred new beam.

Although FIG. 6 shows example blocks of method 600, in some aspects, method 600 may include additional blocks, fewer blocks, different blocks, or differently arranged blocks than those depicted in FIG. 6. Additionally, or alternatively, two or more of the blocks of method 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include a beam failure recovery component 708, among other examples.

In some aspects, the apparatus 700 may be configured to perform one or more operations described herein in connection with FIG. 4. Additionally, or alternatively, the apparatus 700 may be configured to perform one or more methods described herein, such as method 500 of FIG. 5. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The transmission component 704 may transmit, to a base station, a beam failure recovery message that indicates a preferred new beam associated with an SCell, wherein the preferred new beam is not included in a candidate beam set associated with the SCell or has an RSRP that does not satisfy a threshold. The reception component 702 may receive, from the base station, one or more downlink messages that include information to enable communication using the preferred new beam.

The beam failure recovery component 708 may generate the beam failure recovery message, which may include a BFR MAC-CE. For example, in some aspects, the BFR MAC-CE includes a first octet having a field to indicate a beam failure detection associated with the SCell and includes a second octet to indicate information associated with the preferred new beam. In some aspects, the second octet includes a first field to indicate that the candidate beam set associated with the SCell does not include a reference signal that has an RSRP that satisfies the threshold and includes a second field to indicate a reference signal identifier associated with the preferred new beam. In some aspects, the second octet includes a third field to indicate that the reference signal identifier associated with the preferred new beam is reported in the second field.

Additionally, or alternatively, in some aspects, the second octet includes a first field to indicate that the candidate beam set associated with the SCell does not include a reference signal that has an RSRP that satisfies the threshold and includes a second field to indicate that a reference signal identifier is not reported for the preferred new beam. In some aspects, the second field includes a codepoint or an individual bit that is set to a defined value to indicate that the reference signal identifier is not reported for the preferred new beam.

The number and arrangement of components shown in FIG. 7 are provided as an example. In practice, there may be additional components, fewer components, different components, or differently arranged components than those shown in FIG. 7.

Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram illustrating an example 800 of a hardware implementation for an apparatus 805 employing a processing system 810. The apparatus 805 may be a UE.

The processing system 810 may be implemented with a bus architecture, represented generally by the bus 815. The bus 815 may include any number of interconnecting buses and bridges depending on the specific application of the processing system 810 and the overall design constraints. The bus 815 links together various circuits including one or more processors and/or hardware components, represented by the processor 820, the illustrated components, and the computer-readable medium/memory 825. The bus 815 may also link various other circuits, such as timing sources, peripherals, voltage regulators, and/or power management circuits.

The processing system 810 may be coupled to a transceiver 830. The transceiver 830 is coupled to one or more antennas 835. The transceiver 830 provides a means for communicating with various other apparatuses over a transmission medium. The transceiver 830 receives a signal from the one or more antennas 835, extracts information from the received signal, and provides the extracted information to the processing system 810, specifically the reception component 702. In addition, the transceiver 830 receives information from the processing system 810, specifically the transmission component 704, and generates a signal to be applied to the one or more antennas 835 based at least in part on the received information.

The processing system 810 includes a processor 820 coupled to a computer-readable medium/memory 825. The processor 820 is responsible for general processing, including the execution of software stored on the computer-readable medium/memory 825. The software, when executed by the processor 820, causes the processing system 810 to perform the various functions described herein for any particular apparatus. The computer-readable medium/memory 825 may also be used for storing data that is manipulated by the processor 820 when executing software. The processing system further includes at least one of the illustrated components. The components may be software modules running in the processor 820, resident/stored in the computer readable medium/memory 825, one or more hardware modules coupled to the processor 820, or some combination thereof.

In some aspects, the processing system 810 may be a component of the UE 120 and may include the memory 282 and/or at least one of the TX MIMO processor 266, the RX processor 258, and/or the controller/processor 280. In some aspects, the apparatus 805 for wireless communication includes means for transmitting, to a base station, a beam failure recovery message that indicates a preferred new beam associated with an SCell, wherein the preferred new beam is not included in a candidate beam set associated with the SCell or has an RSRP that does not satisfy a threshold; and means for receiving, from the base station, one or more downlink messages that include information to enable communication using the preferred new beam. The aforementioned means may be one or more of the aforementioned components of the apparatus 700 and/or the processing system 810 of the apparatus 805 configured to perform the functions recited by the aforementioned means. As described elsewhere herein, the processing system 810 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 8 is provided as an example. Other examples may differ from what is described in connection with FIG. 8.

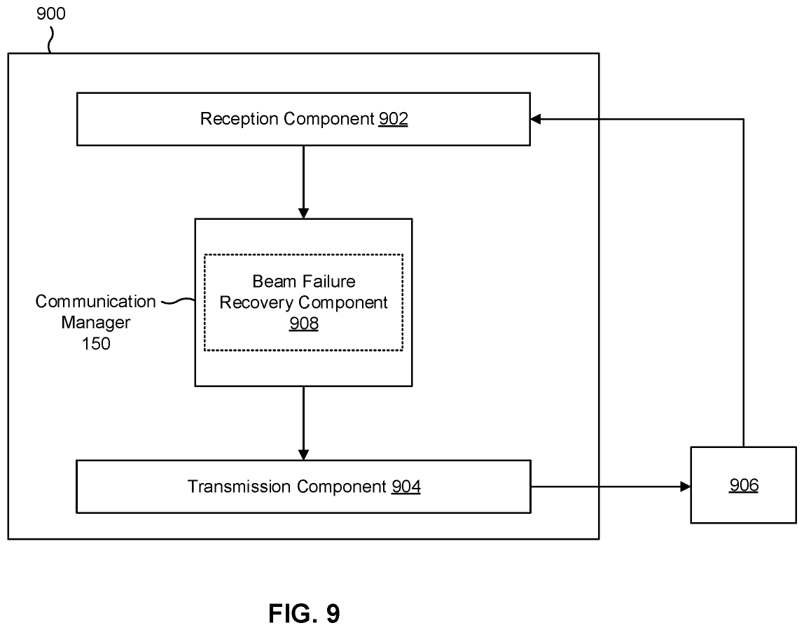

FIG. 9 is a diagram of an example apparatus 900 for wireless communication. The apparatus 900 may be a base station, or a base station may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include a beam failure recovery component 908, among other examples.

In some aspects, the apparatus 900 may be configured to perform one or more operations described herein in connection with FIG. 4. Additionally, or alternatively, the apparatus 900 may be configured to perform one or more methods described herein, such as method 600 of FIG. 6. In some aspects, the apparatus 900 and/or one or more components shown in FIG. 9 may include one or more components of the base station described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a modem, a demodulator, a MIMO detector, a receive processor, a controller/processor, a memory, or a combination thereof, of the base station described in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the base station described in connection with FIG. 2. In some aspects, the transmission component 904 may be co-located with the reception component 902 in a transceiver.

The reception component 902 may receive, from a UE, a beam failure recovery message that indicates a preferred new beam associated with an SCell, wherein the preferred new beam is not included in a candidate beam set associated with the SCell or has an RSRP that does not satisfy a threshold. The transmission component 904 may transmit, to the UE, one or more downlink messages that include information to enable communication using the preferred new beam.

The beam failure recovery component 908 may process the beam failure recovery message, which may include a BFR MAC-CE. For example, in some aspects, the BFR MAC-CE includes a first octet having a field to indicate a beam failure detection associated with the SCell and includes a second octet to indicate information associated with the preferred new beam. In some aspects, the second octet includes a first field to indicate that the candidate beam set associated with the SCell does not include a reference signal that has an RSRP that satisfies the threshold and includes a second field to indicate a reference signal identifier associated with the preferred new beam. In some aspects, the second octet includes a third field to indicate that the reference signal identifier associated with the preferred new beam is reported in the second field.

Additionally, or alternatively, in some aspects, the second octet includes a first field to indicate that the candidate beam set associated with the SCell does not include a reference signal that has an RSRP that satisfies the threshold and includes a second field to indicate that a reference signal identifier is not reported for the preferred new beam. In some aspects, the second field includes a codepoint or an individual bit that is set to a defined value to indicate that the reference signal identifier is not reported for the preferred new beam.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

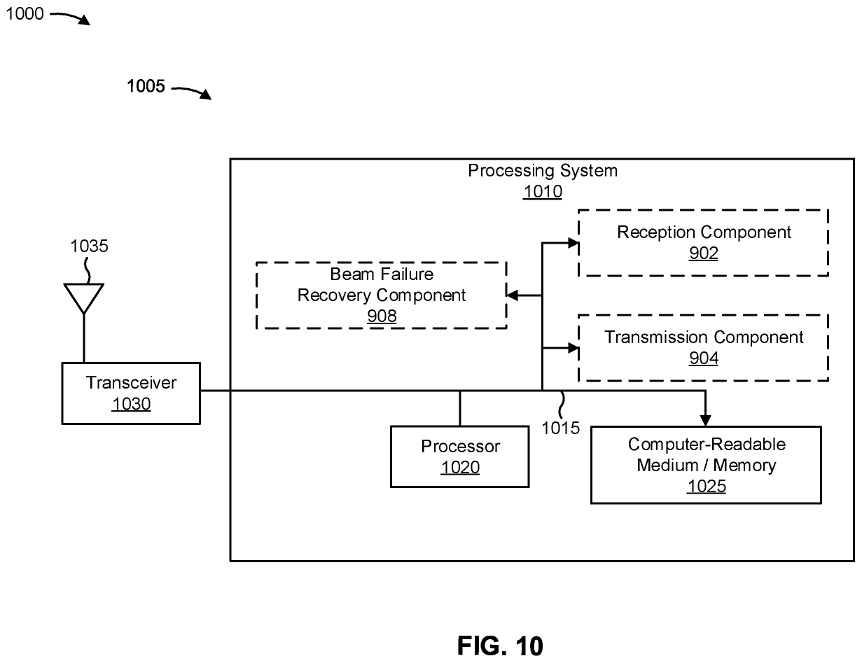

FIG. 10 is a diagram illustrating an example 1000 of a hardware implementation for an apparatus 1005 employing a processing system 1010. The apparatus 1005 may be a base station.

The processing system 1010 may be implemented with a bus architecture, represented generally by the bus 1015. The bus 1015 may include any number of interconnecting buses and bridges depending on the specific application of the processing system 1010 and the overall design constraints. The bus 1015 links together various circuits including one or more processors and/or hardware components, represented by the processor 1020, the illustrated components, and the computer-readable medium/memory 1025. The bus 1015 may also link various other circuits, such as timing sources, peripherals, voltage regulators, and/or power management circuits.

The processing system 1010 may be coupled to a transceiver 1030. The transceiver 1030 is coupled to one or more antennas 1035. The transceiver 1030 provides a means for communicating with various other apparatuses over a transmission medium. The transceiver 1030 receives a signal from the one or more antennas 1035, extracts information from the received signal, and provides the extracted information to the processing system 1010, specifically the reception component 902. In addition, the transceiver 1030 receives information from the processing system 1010, specifically the transmission component 904, and generates a signal to be applied to the one or more antennas 1035 based at least in part on the received information.

The processing system 1010 includes a processor 1020 coupled to a computer-readable medium/memory 1025. The processor 1020 is responsible for general processing, including the execution of software stored on the computer-readable medium/memory 1025. The software, when executed by the processor 1020, causes the processing system 1010 to perform the various functions described herein for any particular apparatus. The computer-readable medium/memory 1025 may also be used for storing data that is manipulated by the processor 1020 when executing software. The processing system further includes at least one of the illustrated components. The components may be software modules running in the processor 1020, resident/stored in the computer readable medium/memory 1025, one or more hardware modules coupled to the processor 1020, or some combination thereof.

In some aspects, the processing system 1010 may be a component of the base station 110 and may include the memory 242 and/or at least one of the TX MIMO processor 230, the RX processor 238, and/or the controller/processor 240. In some aspects, the apparatus 1005 for wireless communication includes means for receiving, from a UE, a beam failure recovery message that indicates a preferred new beam associated with an SCell, wherein the preferred new beam is not included in a candidate beam set associated with the SCell or has an RSRP that does not satisfy a threshold; and means for transmitting, to the UE, one or more downlink messages that include information to enable communication using the preferred new beam. The aforementioned means may be one or more of the aforementioned components of the apparatus 900 and/or the processing system 1010 of the apparatus 1005 configured to perform the functions recited by the aforementioned means. As described elsewhere herein, the processing system 1010 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 10 is provided as an example. Other examples may differ from what is described in connection with FIG. 10.

The following provides an overview of some Aspects of the present disclosure:

Aspect 1: A method of wireless communication performed by a UE, comprising: transmitting, to a base station, a beam failure recovery message that indicates a preferred new beam associated with an SCell, wherein the preferred new beam is not included in a candidate beam set associated with the SCell or has an RSRP that does not satisfy a threshold; and receiving, from the base station, one or more downlink messages that include information to enable communication using the preferred new beam.

Aspect 2: The method of Aspect 1, wherein the beam failure recovery message indicates the preferred new beam according to a TCI state identifier.

Aspect 3: The method of Aspect 1, wherein the beam failure recovery message indicates the preferred new beam according to a CSI-RS identifier associated with a bandwidth part.

Aspect 4: The method of Aspect 1, wherein the beam failure recovery message indicates the preferred new beam according to a joint identifier associated with an SSB and a CSI-RS.

Aspect 5: The method of any of Aspects 1-4, wherein the beam failure recovery message includes a BFR MAC-CE.

Aspect 6: The method of Aspect 5, wherein the BFR MAC-CE includes a first octet having a field to indicate a beam failure detection associated with the SCell and includes a second octet to indicate information associated with the preferred new beam.

Aspect 7: The method of Aspect 6, wherein the second octet includes a first field to indicate that the candidate beam set associated with the SCell does not include a reference signal that has an RSRP that satisfies the threshold and includes a second field to indicate a reference signal identifier associated with the preferred new beam.

Aspect 8: The method of Aspect 7, wherein the second octet includes a third field to indicate that the reference signal identifier associated with the preferred new beam is reported in the second field.

Aspect 9: The method of Aspect 6, wherein the second octet includes a first field to indicate that the candidate beam set associated with the SCell does not include a reference signal that has an RSRP that satisfies the threshold and includes a second field to indicate that a reference signal identifier is not reported for the preferred new beam.

Aspect 10: The method of Aspect 9, wherein the second field includes a codepoint or an individual bit that is set to a defined value to indicate that the reference signal identifier is not reported for the preferred new beam.

Aspect 11: A method of wireless communication performed by a base station, comprising: receiving, from a UE, a beam failure recovery message that indicates a preferred new beam associated with an SCell, wherein the preferred new beam is not included in a candidate beam set associated with the SCell or has an RSRP that does not satisfy a threshold; and transmitting, to the UE, one or more downlink messages that include information to enable communication using the preferred new beam.

Aspect 12: The method of Aspect 11, wherein the beam failure recovery message indicates the preferred new beam according to a TCI state identifier.

Aspect 13: The method of Aspect 11, wherein the beam failure recovery message indicates the preferred new beam according to a CSI-RS identifier associated with a bandwidth part.

Aspect 14: The method of Aspect 11, wherein the beam failure recovery message indicates the preferred new beam according to a joint identifier associated with an SSB and a CSI-RS.

Aspect 15: The method of any of Aspects 11-14, wherein the beam failure recovery message includes a BFR MAC-CE.

Aspect 16: The method of Aspect 15, wherein the BFR MAC-CE includes a first octet having a field to indicate a beam failure detection associated with the SCell and includes a second octet to indicate information associated with the preferred new beam.

Aspect 17: The method of Aspect 16, wherein the second octet includes a first field to indicate that the candidate beam set associated with the SCell does not include a reference signal that has an RSRP that satisfies the threshold and includes a second field to indicate a reference signal identifier associated with the preferred new beam.

Aspect 18: The method of Aspect 17, wherein the second octet includes a third field to indicate that the reference signal identifier associated with the preferred new beam is reported in the second field.

Aspect 19: The method of Aspect 16, wherein the second octet includes a first field to indicate that the candidate beam set associated with the SCell does not include a reference signal that has an RSRP that satisfies the threshold and includes a second field to indicate that a reference signal identifier is not reported for the preferred new beam.

Aspect 20: The method of Aspect 19, wherein the second field includes a codepoint or an individual bit that is set to a defined value to indicate that the reference signal identifier is not reported for the preferred new beam.

Aspect 21: An apparatus for wireless communication at a device, comprising a processor; memory coupled with the processor; and instructions stored in the memory and executable by the processor to cause the apparatus to perform the method of one or more of Aspects 1-10.

Aspect 22: A device for wireless communication, comprising a memory and one or more processors coupled to the memory, the one or more processors configured to perform the method of one or more of Aspects 1-10.

Aspect 23: An apparatus for wireless communication, comprising at least one means for performing the method of one or more of Aspects 1-10.

Aspect 24: A non-transitory computer-readable medium storing code for wireless communication, the code comprising instructions executable by a processor to perform the method of one or more of Aspects 1-10.

Aspect 25: A non-transitory computer-readable medium storing a set of instructions for wireless communication, the set of instructions comprising one or more instructions that, when executed by one or more processors of a device, cause the device to perform the method of one or more of Aspects 1-10.

Aspect 26: An apparatus for wireless communication at a device, comprising a processor; memory coupled with the processor; and instructions stored in the memory and executable by the processor to cause the apparatus to perform the method of one or more of Aspects 11-20.

Aspect 27: A device for wireless communication, comprising a memory and one or more processors coupled to the memory, the one or more processors configured to perform the method of one or more of Aspects 11-20.

Aspect 28: An apparatus for wireless communication, comprising at least one means for performing the method of one or more of Aspects 11-20.

Aspect 29: A non-transitory computer-readable medium storing code for wireless communication, the code comprising instructions executable by a processor to perform the method of one or more of Aspects 11-20.

Aspect 30: A non-transitory computer-readable medium storing a set of instructions for wireless communication, the set of instructions comprising one or more instructions that, when executed by one or more processors of a device, cause the device to perform the method of one or more of Aspects 11-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a +c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit, to a base station, a beam failure recovery message that indicates a preferred new beam associated with a secondary cell (SCell), wherein the preferred new beam is not included in a candidate beam set associated with the SCell or has a reference signal received power (RSRP) that does not satisfy a threshold; and
receive, from the base station, one or more downlink messages that include information to enable communication using the preferred new beam.

2. The UE of claim 1, wherein the beam failure recovery message indicates the preferred new beam according to a transmission configuration indication state identifier.

3. The UE of claim 1, wherein the beam failure recovery message indicates the preferred new beam according to a channel state information reference signal identifier associated with a bandwidth part.

4. The UE of claim 1, wherein the beam failure recovery message indicates the preferred new beam according to a joint identifier associated with a synchronization signal block and a channel state information reference signal.

5. The UE of claim 1, wherein the beam failure recovery message includes a beam failure detection medium access control control element (BFR MAC-CE).

6. The UE of claim 5, wherein the BFR MAC-CE includes a first octet having a field to indicate a beam failure detection associated with the SCell and includes a second octet to indicate information associated with the preferred new beam.

7. The UE of claim 6, wherein the second octet includes a first field to indicate that the candidate beam set associated with the SCell does not include a reference signal that has an RSRP that satisfies the threshold and includes a second field to indicate a reference signal identifier associated with the preferred new beam.

8. The UE of claim 7, wherein the second octet includes a third field to indicate that the reference signal identifier associated with the preferred new beam is reported in the second field.

9. The UE of claim 6, wherein the second octet includes a first field to indicate that the candidate beam set associated with the SCell does not include a reference signal that has an RSRP that satisfies the threshold and includes a second field to indicate that a reference signal identifier is not reported for the preferred new beam.

10. The UE of claim 9, wherein the second field includes a codepoint or an individual bit that is set to a defined value to indicate that the reference signal identifier is not reported for the preferred new beam.

11. A base station for wireless communication, comprising:
a memory; and
one or more processors, coupled to the memory, configured to:
receive, from a user equipment (UE), a beam failure recovery message that indicates a preferred new beam associated with a secondary cell (SCell), wherein the preferred new beam is not included in a candidate beam set associated with the SCell or has a reference signal received power (RSRP) that does not satisfy a threshold; and
transmit, to the UE, one or more downlink messages that include information to enable communication using the preferred new beam.

12. The base station of claim 11, wherein the beam failure recovery message indicates the preferred new beam according to a transmission configuration indication state identifier.

13. The base station of claim 11, wherein the beam failure recovery message indicates the preferred new beam according to a channel state information reference signal identifier associated with a bandwidth part.

14. The base station of claim 11, wherein the beam failure recovery message indicates the preferred new beam according to a joint identifier associated with a synchronization signal block and a channel state information reference signal.

15. The base station of claim 11, wherein the beam failure recovery message includes a beam failure detection medium access control control element (BFR MAC-CE).

16. The base station of claim 15, wherein the BFR MAC-CE includes a first octet having a field to indicate a beam failure detection associated with the SCell and includes a second octet to indicate information associated with the preferred new beam.

17. The base station of claim 16, wherein the second octet includes a first field to indicate that the candidate beam set associated with the SCell does not include a reference signal that has an RSRP that satisfies the threshold and includes a second field to indicate a reference signal identifier associated with the preferred new beam.

18. The base station of claim 17, wherein the second octet includes a third field to indicate that the reference signal identifier associated with the preferred new beam is reported in the second field.

19. The base station of claim 16, wherein the second octet includes a first field to indicate that the candidate beam set associated with the SCell does not include a reference signal that has an RSRP that satisfies the threshold and includes a second field to indicate that a reference signal identifier is not reported for the preferred new beam.

20. The base station of claim 19, wherein the second field includes a codepoint or an individual bit that is set to a defined value to indicate that the reference signal identifier is not reported for the preferred new beam.

21. A method of wireless communication performed by a user equipment (UE), comprising:
transmitting, to a base station, a beam failure recovery message that indicates a preferred new beam associated with a secondary cell (SCell), wherein the preferred new beam is not included in a candidate beam set associated with the SCell or has a reference signal received power (RSRP) that does not satisfy a threshold; and
receiving, from the base station, one or more downlink messages that include information to enable communication using the preferred new beam.

22. The method of claim 21, wherein the beam failure recovery message indicates the preferred new beam according to a transmission configuration indication state identifier, a channel state information reference signal (CSI-RS) identifier associated with a bandwidth part, or a joint identifier associated with a synchronization signal block and a CSI-RS.

23. The method of claim 21, wherein the beam failure recovery message includes a beam failure detection medium access control control element (BFR MAC-CE) that includes a first octet having a field to indicate a beam failure detection associated with the SCell and includes a second octet to indicate information associated with the preferred new beam.

24. The method of claim 23, wherein the second octet includes a first field to indicate that the candidate beam set associated with the SCell does not include a reference signal that has an RSRP that satisfies the threshold and includes a second field to indicate a reference signal identifier associated with the preferred new beam.

25. The method of claim 23, wherein the second octet includes a first field to indicate that the candidate beam set associated with the SCell does not include a reference signal that has an RSRP that satisfies the threshold and includes a second field to indicate that a reference signal identifier is not reported for the preferred new beam.

26. A method of wireless communication performed by a base station, comprising:
receiving, from a user equipment (UE), a beam failure recovery message that indicates a preferred new beam associated with a secondary cell (SCell), wherein the preferred new beam is not included in a candidate beam set associated with the SCell or has a reference signal received power (RSRP) that does not satisfy a threshold; and
transmitting, to the UE, one or more downlink messages that include information to enable communication using the preferred new beam.

27. The method of claim 26, wherein the beam failure recovery message indicates the preferred new beam according to a transmission configuration indication state identifier, a channel state information reference signal (CSI-RS) identifier associated with a bandwidth part, or a joint identifier associated with a synchronization signal block and a CSI-RS.

28. The method of claim 26, wherein the beam failure recovery message includes a beam failure detection medium access control control element (BFR MAC-CE) that includes a first octet having a field to indicate a beam failure detection associated with the SCell and includes a second octet to indicate information associated with the preferred new beam.

29. The method of claim 28, wherein the second octet includes a first field to indicate that the candidate beam set associated with the SCell does not include a reference signal that has an RSRP that satisfies the threshold and includes a second field to indicate a reference signal identifier associated with the preferred new beam.

30. The method of claim 28, wherein the second octet includes a first field to indicate that the candidate beam set associated with the SCell does not include a reference signal that has an RSRP that satisfies the threshold and includes a second field to indicate that a reference signal identifier is not reported for the preferred new beam.
